(19) United States
(12) Patent Application Publication
(10) Pub. No.: US 2015/0039358 A1
(43) Pub. Date: Feb. 5, 2015

(54) DATA PERSISTENCE TECHNOLOGY CONFIGURATOR

(71) Applicant: International Business Machines Corporation, Armonk, NY (US)

(72) Inventors: Murthy V. Rallapalli, Atlanta, GA (US); Barry S. Rosen, Bedford, MA (US); Daniel B. Sutherland, Colorado Springs, CO (US)

(73) Assignee: International Business Machines Corporation, Armonk, NY (US)

(21) Appl. No.: 13/955,097

(22) Filed: Jul. 31, 2013

(51) Int. Cl. G06Q 10/06

(52) U.S. Cl. CPC G06Q 10/063
USPC 705/7.11

(57) ABSTRACT

A computer system receives data persistence requirements necessary for a system architecture. The computer system identifies one or more data persistence technology attributes corresponding to the received data persistence requirements. The computer system determines one or more data persistence technology products having one or more of the identified data persistence technology attributes. The computer system, based on a priority of data persistence requirements, determines at least one data persistence technology product from the one or more determined data persistence technology products for the system architecture.

### FIELD OF THE INVENTION

The present invention relates generally to the field of system architecture design, and more particularly to determining an optimal data persistence technology.

### BACKGROUND OF THE INVENTION

As businesses increasingly rely upon computer technology to perform essential functions, data analytics is rapidly becoming vital to business success. Specifically, many businesses gather various types of data about the business and/or its customers so operations can be gauged and optimized. Typically, a business gathers data into a database, or a similar data persistence storage mechanism, and then utilizes various analytics methods to analyze the data.

Smarter Analytics enhances organizational and overall business performance by applying advanced mathematical modeling, deep computing, simulation, data analytics and optimization techniques to improve operational efficiency. A base reference architecture, and, at a deeper level, the appropriate technology used for data persistence, serve as important components for a robust foundation of any Smarter Analytics architectural solution. System architects often find it a challenge to design a solution where the appropriate data persistence technology provides optimal performance and functionality with secure access.

### SUMMARY

Embodiments of the present invention disclose a method, computer program product, and system for recommending a data persistence technology product. A computer system receives data persistence requirements necessary for a system architecture. The computer system identifies one or more data persistence technology attributes corresponding to the received data persistence requirements. The computer system determines one or more data persistence technology products having one or more of the identified data persistence technology attributes. The computer system, based on a priority of data persistence requirements, determines at least one data persistence technology product from the one or more determined data persistence technology products for the system architecture.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a high level process flow of the steps of a configurator program residing on a server computer within the data processing environment of FIG. 1, for recommending data persistence technology products, in accordance with an embodiment of the present invention.

FIG. 3 is a flowchart depicting operational steps for one implementation of a configurator program on a server computer within the data processing environment of FIG. 1, in accordance with an embodiment of the present invention.

FIG. 4 is an exemplary table depicting data persistence technology products and attributes that may be found in a database within the data processing environment of FIG. 1, in accordance with an embodiment of the present invention.

FIG. 5 depicts a block diagram of components of the server computer executing the configurator program, in accordance with an embodiment of the present invention.

### DETAILED DESCRIPTION

As a system architect begins to plan an architectural solution, he chooses a data persistence technology. Data persistence technologies are proliferating across the technological landscape and come in many forms, for example, browser-based, in-memory, flat-file, etc. Embodiments of the present invention recognize the value of providing a disciplined, methodical approach to selecting the optimal data persistence technology for a given customer application. Embodiments of the present invention can assist a system architect to select the appropriate data persistence product(s) based on an evaluation of functional and non-functional requirements driven by questions delivered through a configurator program. Implementation of embodiments of the invention may take a variety of forms, and exemplary implementation details are discussed subsequently with reference to the Figures.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

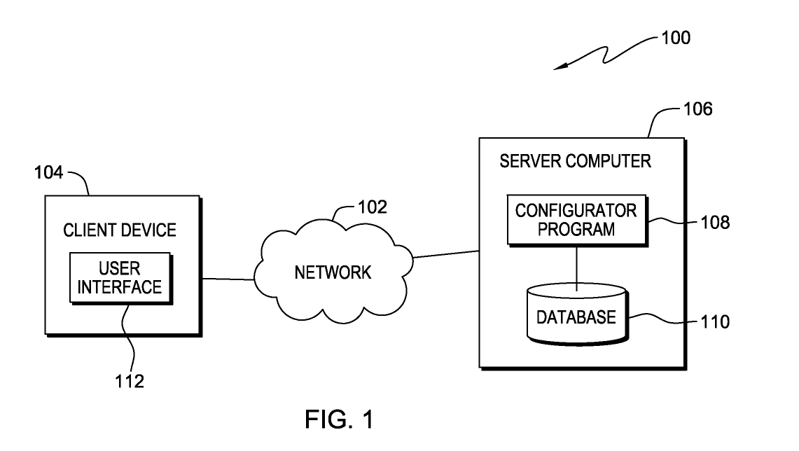

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made. In the illustrated embodiment, distributed data processing environment 100 comprises client device 104 and server computer 106 interconnected via network 102.

Server computer 106 may be a laptop computer, tablet computer, netbook computer, personal computer (PC), a desktop computer, a personal digital assistant (PDA), a smart phone, or any programmable electronic device capable of communicating with client device 104 via network 102. Server computer 106 may communicate with client device 104 via network 102.

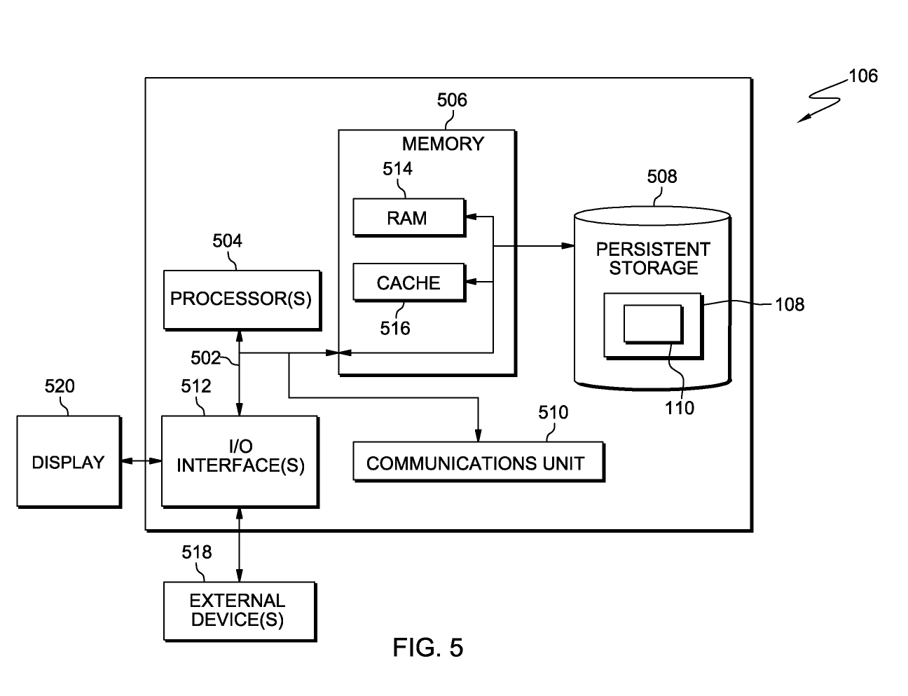

Server computer 106 includes configurator program 108 and database 110. Server computer 106 may include internal and external hardware components, as depicted and described in further detail with respect to FIG. 5.

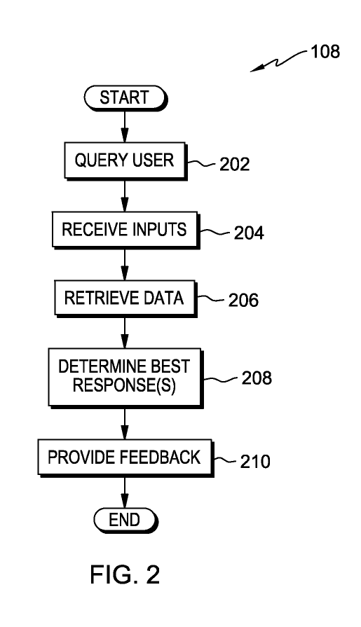

Configurator program 108 provides a methodical process for a system architect to choose an optimal data persistence technology for use in a system architecture. According to an illustrative embodiment, configurator program 108 translates user input from an online data persistence requirements focused questionnaire. A Decision Tree/Knowledge/Rules Engine within configurator program 108 translates user input from the questionnaire into one or more decision trees. The decision trees drive query paths against the persistence data technology database, e.g. database 110, to produce client specific output. Based on customer functional and non-functional requirements, as well as further data received through a guided questionnaire, configurator program 108 may recommend available products for optimal data persistence in the system architecture. One implementation of configurator program 108 is described in further detail with respect to FIG. 2.

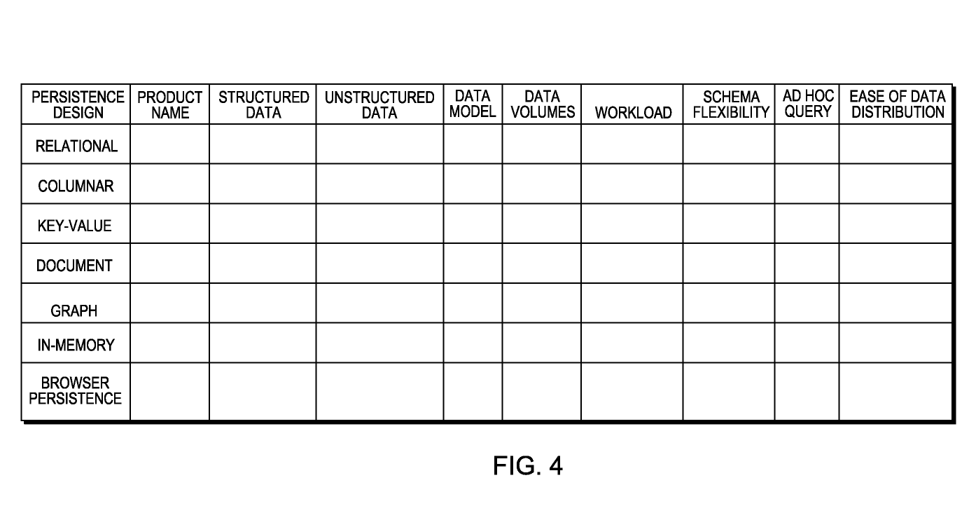

Database 110 stores the persistence data technology information which configurator program 108 uses to provide a recommendation to the user. The information in database 110 is classified as persistence data requirements and technology attributes. An example of data stored in database 110 is described in further detail with respect to FIG. 4.

Client device 104 may be a desktop computer, a laptop computer, a tablet computer, a specialized computer server, a smartphone, or any other computer system known in the art. In general, client device 104 represents any programmable electronic device or combination of programmable electronic devices capable of executing machine-readable program instructions and communicating with other computing devices via a network. Client device 104 includes user interface 112.

User interface 112 provides an interface for client device 104 to communicate, via network 102, with configurator program 108 on server computer 106. In one embodiment, user interface 112 may be a web-based user interface accessible to each respective user via network 102. In some illustrative embodiments, user interface 112 may be downloaded over network 102 from another device or data processing system, e.g. server computer 106. For example, program code stored in a computer readable storage medium in a server data processing system may be downloaded over a network from the server computer to client device 104. The data processing system providing user interface 112 may be a server computer, a client computer or some other device capable of storing and transmitting program code.

In one embodiment, configurator program 108 and database 110 may be downloaded to client device 104 via network 102, and user interface 112, internal to client device 104, may access configurator program 108 and database 110 directly. Configurator program 108 functions similarly on client device 104 as on server computer 106. In this embodiment, the user of client device 104 may request maintenance updates via network 102 to configurator program 108 and database 110 from the administrator of configurator program 108 and database 110 as changes occur due to updates, such as the addition of new data persistence technology products to database 110.

In general, network 102 may be any combination of connections and protocols that supports communications between client device 104 and server computer 106. Network 102 may include, for example, a local area network (LAN), a wide area network (WAN) such as the internet, a cellular network, or any combination of the preceding, and may further include wired, wireless, and/or fiber optic connections.

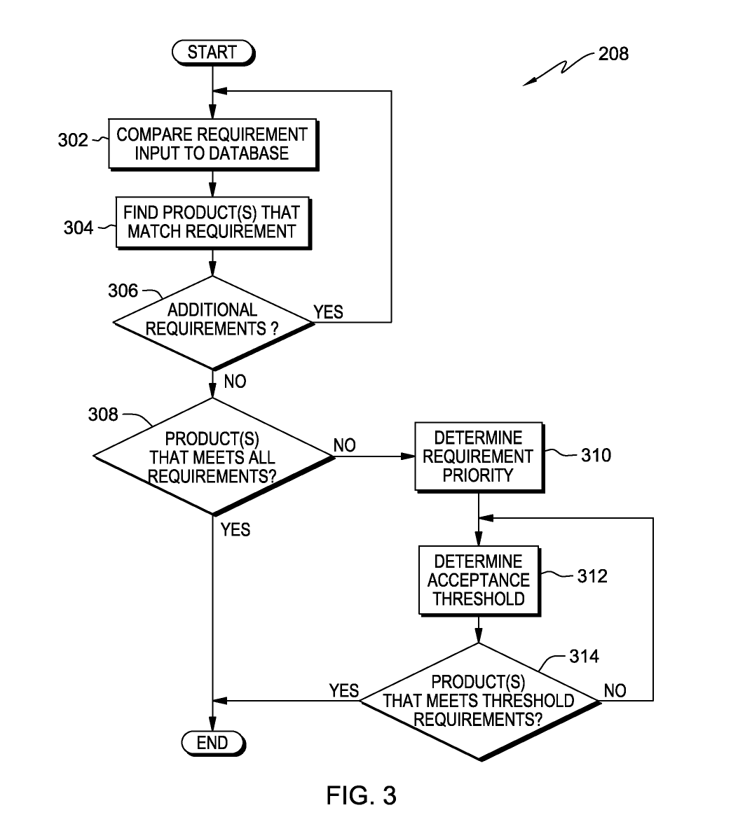

FIG. 2 depicts a high level process flow taken by configurator program 108 residing on server computer 106. A more detailed implementation is discussed with regard to FIG. 3. Configurator program 108 queries the user regarding the data persistence requirements of the user's system architecture application (step 202). In one embodiment, a data persistence requirements focused guided questionnaire asks the user a series of questions designed to ascertain the customer requirements and narrow the list of optimal persistence data technology products for the specific application. The guided questionnaire may be a series of questions and/or prompts designed to elicit further information from the user for choosing the optimal data persistence technology product(s). For example, the guided questionnaire may be a drilldown questionnaire, designed to prompt the user for progressively more detailed information regarding the application requirements for data persistence. Each subsequent question in the drilldown questionnaire may be based on responses to previous questions in the drilldown questionnaire, as well as customer functional and nonfunctional requirements.

Take for example the following scenario:

The first question asked may be “Is the data persistence going to a database server, application server or is it browser-based?” The user chooses one of the three choices from a list: database server; application server; browser-based.

In the example, the user chooses “Database server.”

The next question may be “Is the data at rest or in motion?” The user chooses one of two choices from a list: Data at rest; Data in motion.

In the example, the user chooses “Data at rest.”

The next question may be “Is the data structured or unstructured?” The user chooses one of two choices from a list: Structured; Unstructured.

In the example, the user chooses “Structured.”

The next question may be “Are comprehensive, explicit and highly defined data relationships important?” The user chooses one of two choices from a list: Yes; No.

In the example, the user chooses “Yes.”

The next question may be “Is premier customer support important?” The user chooses one of two choices from a list: Yes; No.

In the example, the user chooses “Yes.” Based on the user's chosen answers to these questions, configurator program 108 recommends two data persistence products: IBM DB2® and Teradata®.

As the user answers the questionnaire, the potential product set is narrowed down based on the answers to each question. Configurator program 108 filters the inputs using structured query language (SQL), generated by the questionnaire, against database 110 until the lowest level result set is created. Simple logic prioritizes and weights criteria appropriately. For example, the SQL may be structured as follows:

Select Product_Name

From Product_table

Where Persistence_Category=<answer to question #1, e.g., database server, app server or browser cache>

and Persistence_Style=<answer to question #2), e.g., data at rest or data in motion>

etc.

Code logic is wrapped around to render the SQL based on the question answers and to format the result set to the user.

Subsequent to querying the user, configurator program 108 receives the inputs from the user (step 204). Upon receipt of the inputs, configurator program 108 retrieves the stored data listing all of the data persistence technology products and their various attributes (step 206). Stored data persistence technology attributes may include persistence style, data model, and data volumes. Data models, for example, may be relational, modified relational, a collection of key-value pairs, a collection of documents containing key-value collections, etc. Data volumes may range from low to high. Some data persistence products perform well for complex transactions while others perform better for complex queries. Configurator program 108 determines the best response(s) for data persistence technology based on comparing the user's inputs to the stored data persistence technology attributes and choosing the product(s) most closely meeting all of the user's requirements (step 208). Configurator program 108 provides feedback to the user regarding the optimal data persistence technology product(s) for the system architecture application (step 210). Examples of data persistence technology products include IBM DB2®, MongoDB®, and Teradata®. Configurator program 108 provides the feedback in several formats based on user preferences. In one embodiment, configurator program 108 prompts the user to choose the preferred format of the displayed results. The format of the results may take one or more forms. Examples of feedback formats include PDF®, Microsoft® Word®, and HyperText Markup Language (HTML).

FIG. 3 depicts operational steps for one implementation of configurator program 108 providing data persistence technology recommendations to user interface 112 via network 102. Specifically, FIG. 3 depicts the steps taken within step 208, as discussed in FIG. 2.

Configurator program 108 compares the input requirements received via the data persistence requirements focused questionnaire to the attribute(s) of the data persistence technology products contained in database 110 (step 302). Configurator program 108 identifies one or more products that match the requirements based on a comparison of the requirements to the attribute(s) (step 304). As the user continues to provide answers to the questionnaire, configurator program 108 determines whether additional requirements exist (decision block 306). If additional requirements exist, configurator program 108 continues to match products to the requirements (yes branch, decision block 306). Once the user has input all of the requirements (no branch, decision block 306), configurator program 108 determines whether one or more of the data persistence technology products in database 110 meets all of the user's requirements (decision block 308).

If one or more of the data persistence technology products in database 110 meets all of the user's requirements (yes branch, decision block 308), configurator program 108 displays the recommended product(s) by proceeding to step 210, as discussed in FIG. 2.

If none of the data persistence technology products in database 110 meet all of the user's requirements (no branch, decision block 308), configurator program 108 determines the priority of each of the user's requirements (step 310). Configurator program 108 may determine priority via several methods. In one embodiment, the administrator of configurator program 108 assumes a numerical ranking for each of the data persistence technology attributes residing in database 110. The numerical ranking allows configurator program 108 to put the attributes in order from most critical to least critical. In another embodiment, configurator program 108 asks the user to rank the attributes as part of the questionnaire. In another embodiment, configurator program 108 may determine the priority by allowing a percentage of the data persistence technology attributes to match the user's requirements. For example, configurator program 108 may require the chosen data persistence technology to match 60% of the attributes stated in the questionnaire. In another example, the user may define the required percentage match based on the criticality of the application.

Once configurator program 108 establishes the requirement priority, configurator program 108 determines an acceptance threshold (step 312). In one embodiment, if each attribute has a numerical ranking, configurator program 108 may determine the acceptance threshold requires the top five attributes be met. In another embodiment, configurator program 108 may ask the user for input to determine the acceptance threshold. The user may decide the top ten attributes are the highest priority and must be met in order to satisfy the application requirements for data persistence.

Configurator program 108 determines whether one or more data persistence technology products meet the threshold requirements (decision block 314). If one or more of the data persistence technology products in database 110 meet the threshold requirements (yes branch, decision block 314), configurator program 108 displays the recommended product(s) by proceeding to step 210, as discussed in FIG. 2.

If no data persistence technology products in database 110 meet the threshold amount of requirements (no branch, decision block 314), configurator program 108 determines a different acceptance threshold, allowing configurator program 108 to choose at least one of the data persistence technology products. For example, if the data persistence attributes in database 110 have been numerically ranked, and an acceptance threshold of the top 5 attributes does not produce a match, configurator program 108 may lower the acceptance threshold to the top 3 attributes. In another example, if the user has defined the acceptance threshold as the top 10 numerically ranked attributes, and the threshold does not produce a match, configurator program 108 may prompt the user to choose a number of attributes less than 10 in order to enable recommending a data persistence technology product that meets the user's requirements. In yet another example, if an acceptance threshold of 60% of the attributes must match the user's requirements does not produce a match, configurator program 108 may alter the acceptance threshold to 40% of the attributes must match. Once the acceptance threshold is altered such that one or more of the data persistence technology products in database 110 meet the threshold requirements (yes branch, decision block 314), configurator program 108 displays the recommended product(s) by proceeding to step 210, as discussed in FIG. 2.

FIG. 4 is a representation of an example of the types of data stored in database 110. The initial table is created by the administrator of database 110. The table may be created by filling in a standard spreadsheet or generating data definition language (DDL) that is used by a database management system. The first column lists the available different design types of data persistence technologies. The second column lists the currently available product(s) for each design type shown in the first column. For example, in the second column, next to the design type “relational”, products such as IBM DB2® and Teradata® may be listed because those products provide data persistence for a relational database. Additional column headings each describe an attribute associated with data persistence technologies that may be important to a system architect. The cells in the column under each attribute heading contain descriptions of available attributes associated with each data persistence technology product. For example, an attribute heading may be “Data Volumes”. The cells in the column under that heading contain “high”, “medium”, or “low” depending on the data persistence technology product to which the cell corresponds. The cells in the column under each attribute heading may also contain a “yes” or “no” if the attribute heading is in the form of a question. For example, an attribute heading may be “Is Ad Hoc Query Available?” The cells in the column under that heading contain either “yes” or “no” depending on the data persistence technology product to which the cell corresponds. The attributes depicted in the Figure are only several examples of attributes. As system architects determine additional critical attributes, additional attribute columns may be added to the database. Similarly, as additional data persistence technology design types and/or products become available, additional rows may be added to the database. Configurator program 108's administrator takes responsibility for maintaining database 110 and ensuring the completeness and currency of the contents.

FIG. 5 depicts a block diagram of components of server computer 106 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Server computer 106 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Configurator program 108 and database 110 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of client device 104. In these examples, communications unit 510 includes one or more network interface cards. Communications unit 510 may provide communications through the use of either or both physical and wireless communications links. Configurator program 108 and database 110 may be downloaded to persistent storage 508 through communications unit 510.

I/O interface(s) 512 allows for input and output of data with other devices that may be connected to server computer 106. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., configurator program 108 and database 110, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for recommending a data persistence technology product, the method comprising:
a computer system receiving data persistence requirements necessary for a system architecture;
the computer system identifying one or more data persistence technology attributes corresponding to the received data persistence requirements;
the computer system determining one or more data persistence technology products having one or more of the identified data persistence technology attributes; and
based on a priority of the data persistence requirements, the computer system determining at least one data persistence technology product, from the determined one or more data persistence technology products, for the system architecture.

2. The method of claim 1, wherein determining the at least one data persistence technology product for the system architecture further comprises:
determining that the data persistence technology product meets a threshold amount of data persistence technology attributes corresponding to the data persistence requirements.

3. The method of claim 1, wherein determining the at least one data persistence technology product for the system architecture further comprises:
determining that none of the determined data persistence technology products meet a threshold amount of data persistence technology attributes corresponding to the data persistence requirements;
lowering the threshold amount of data persistence technology attributes; and
determining that the data persistence technology product meets the threshold amount of data persistence technology attributes corresponding to the data persistence requirements.

4. The method of claim 1, wherein a threshold amount of data persistence technology attributes is selected from one of:
a percentage of the data persistence technology attributes matching the data persistence requirements; and
a select number of data persistence technology attributes matching the data persistence requirements of highest priority to the system architecture.

5. The method of claim 1, further comprising:
presenting a guided questionnaire, comprised of a list of questions, to a user, wherein the guided questionnaire is designed to ascertain the data persistence requirements for the system architecture.

6. The method of claim 1, wherein receiving data persistence requirements necessary for a system architecture further comprises:
displaying a question designed to elicit a response from a user regarding data persistence requirements;
receiving a response to the question; and
based on the received response, displaying another question designed to elicit a second response from the user regarding data persistence requirements.

7. A computer program product for recommending a data persistence technology product, the computer program product comprising:
one or more computer-readable storage media and program instructions stored on the one or more computer-readable storage media, the program instructions comprising:
program instructions to receive data persistence requirements necessary for a system architecture;
program instructions to identify one or more data persistence technology attributes corresponding to the received data persistence requirements;
program instructions to determine one or more data persistence technology products having one or more of the identified data persistence technology attributes; and
program instructions to, based on a priority of the data persistence requirements, determine at least one data persistence technology product, from the determined one or more data persistence technology products, for the system architecture.

8. The computer program product of claim 7, further comprising:
program instructions stored on the one or more computer-readable storage media to determine that the data persistence technology product meets a threshold amount of data persistence technology attributes corresponding to the data persistence requirements.

9. The computer program product of claim 7, further comprising:
program instructions stored on the one or more computer-readable storage media to determine that none of the determined data persistence technology products meet a threshold amount of data persistence technology attributes corresponding to the data persistence requirements;
program instructions stored on the one or more computer-readable storage media to lower the threshold amount of data persistence technology attributes; and
program instructions stored on the one or more computer-readable storage media to determine that the data persistence technology product meets the threshold amount of data persistence technology attributes corresponding to the data persistence requirements.

10. The computer program product of claim 7, further comprising:
program instructions stored on the one or more computer-readable storage media wherein a threshold amount of data persistence technology attributes is selected from one of:
a percentage of the data persistence technology attributes matching the data persistence requirements; and
a select number of data persistence technology attributes matching the data persistence requirements of highest priority to the system architecture.

11. The computer program product of claim 7, further comprising:
program instructions stored on the one or more computer-readable storage media to present a guided questionnaire, comprised of a list of questions, to a user, wherein the guided questionnaire is designed to ascertain the data persistence requirements for the system architecture.

12. The computer program product of claim 7, further comprising:
program instructions stored on the one or more computer-readable storage media to display a question designed to elicit a response from a user regarding data persistence requirements;
program instructions stored on the one or more computer-readable storage media to receive a response to the question; and
program instructions stored on the one or more computer-readable storage media to, based on the received response, display another question designed to elicit a second response from the user regarding data persistence requirements.

13. A computer system for for recommending a data persistence technology product, the computer system comprising:
one or more computer processors;
one or more computer-readable storage media;
program instructions stored on the computer-readable storage media for execution by at least one of the one or more processors, the program instructions comprising:
program instructions to receive data persistence requirements necessary for a system architecture;
program instructions to identify one or more data persistence technology attributes corresponding to the received data persistence requirements;
program instructions to determine one or more data persistence technology products having one or more of the identified data persistence technology attributes; and
program instructions to, based on a priority of the data persistence requirements, determine at least one data persistence technology product, from the determined one or more data persistence technology products, for the system architecture.

14. The computer system of claim 13, further comprising:
program instructions stored on the one or more computer-readable storage media for execution by at least one of the one or more computer processors to:
determine that the data persistence technology product meets a threshold amount of data persistence technology attributes corresponding to the data persistence requirements.

15. The computer system of claim 13, further comprising:
program instructions stored on the one or more computer-readable storage media for execution by at least one of the one or more computer processors to:
determine that none of the determined data persistence technology products meet a threshold amount of data persistence technology attributes corresponding to the data persistence requirements;
lower the threshold amount of data persistence technology attributes; and
determine that the data persistence technology product meets the threshold amount of data persistence technology attributes corresponding to the data persistence requirements.

16. The computer system of claim 13, further comprising:
program instructions stored on the one or more computer-readable storage media for execution by at least one of the one or more computer processors wherein a threshold amount of data persistence technology attributes is selected from one of:
a percentage of the data persistence technology attributes matching the data persistence requirements; and
a select number of data persistence technology attributes matching the data persistence requirements of highest priority to the system architecture.

17. The computer system of claim 13, further comprising:
program instructions stored on the one or more computer-readable storage media for execution by at least one of the one or more computer processors to present a guided questionnaire, comprised of a list of questions, to a user, wherein the guided questionnaire is designed to ascertain the data persistence requirements for the system architecture.

18. The computer system of claim 13, further comprising:
program instructions stored on the one or more computer-readable storage media for execution by at least one of the one or more computer processors to:
display a question designed to elicit a response from a user regarding data persistence requirements;
receive a response to the question; and
based on the received response, display another question designed to elicit a second response from the user regarding data persistence requirements.
